(19) United States
(12) Patent Application Publication
(10) Pub. No.: US 2004/0124393 A1
(43) Pub. Date: Jul. 1, 2004

(54) Valve seal structure

(75) Inventor: Hideyuki Shimomura, Gamo-gun (JP)

Correspondence Address: KODA & ANDROLIA, 2029 CENTURY PARK EAST, SUITE 1430, LOS ANGELES, CA, 90067-3024, US

(73) Assignee: Okumura Engineering Corp.

(21) Appl. No.: 10/674,928

(22) Filed: Sep. 30, 2003

(30) Foreign Application Priority Data
Sep. 30, 2002 (JP) 2002-285823

(51) Int. Cl. F16K 1/00

(52) U.S. Cl. 251/328; 251/332; 251/360

(57) ABSTRACT

A valve seal structure enabling the replacement of a metal seal ring, comprising a main body, a metal seat ring prepared separately from the main body to seal a flow channel of the main body, a set ring assembling the metal ring seat to the main body at the periphery of the flow channel in a detachable manner, a first elastomeric ring sheet to seal the boundary between the metal seal ring and the main body and a second ring sheet to seal the boundary between the metal seat ring and the set ring.

### BACKGROUND OF THE INVENTION

1. Field of the Invention

The present invention relates to a valve mechanism comprising a main body and a valve plate to open and close a flow channel of the main body and particularly to a valve seal structure to seal a periphery of the flow channel of the main body with a metal seat.

2. Prior Art

In cases where fluids flowing through a pipe line are highly concentrated, high viscosity fluids such as slurries, pulps, powders, etc., gate valves are commonly used as valve mechanisms to control fluid flow by opening and closing a pipe line. Gate valves open and close a flow channel of the main body with a valve plate. A knife gate valve cuts foreign substances contained in fluids with a knife-edge portion formed at the lower end of the valve plate.

At an inner circumferential surface of the valve body, a seat ring is provided so as to seal a periphery of a flow channel, and thereby fluid leakage is prevented from occurring at a gap between an inner circumferential surface of the valve body and a valve plate. Seat rings are made by resin sheets e.g. fluorocarbon resin such as polytetrafluoroethylene, rubber sheets, and metal sheets such as stainless steel sheets. The material of the seat ring is decided depending upon the type of fluid in view of sealing properties, heat resistance, wear resistance, and other performance requirements.

Seat rings made of resin sheets or rubber sheets are commonly prepared separately from the main body and installed at the periphery of the flow channel in a detachable manner. In such cases, the seat ring can be replaced in accordance with the type of fluid, thus resulting in sharing the main body. Besides, as a result of long-term use, when the seat ring becomes worn out, only the seat ring can be replaced.

On the other hand, seat rings made of metal sheets are provided integrally with the main body. And as a result, such seat rings cannot be removed from the main body as in the case of seat rings made of resin sheets and rubber sheets. Accordingly, when the type of fluid to be controlled changes or when a seat ring becomes worn out due to abrasive fluids, it becomes necessary to replace not only a seat ring but also the main body. It results in the increase of maintenance cost and a lot of trouble works are required for maintenance.

### SUMMARY OF THE INVENTION

It is, therefore, an object of the present invention to provide a valve seal structure in which a seat ring made of metal sheet can be replaced, so that the main body can be used in common with any types of fluids.

In order to accomplish the above-described object, the present invention provides a valve seal structure for a valve mechanism having a main body and a valve plate to open and close a flow channel of the main body, wherein a metal seat ring to seal a periphery of the flow channel is prepared separately from the main body and is assembled to the main body at the periphery of the flow channel in a detachable manner.

Thus, a metal seat ring can be replaced with a seat ring made of other materials in accordance with the type of fluid, and a worn metal seat ring can be replaced with a new one.

According to the present invention, a metal seat ring is assembled at the periphery of the flow channel by a set ring and elastomeric ring sheets are provided respectively between the metal seat ring and the main body and between the metal seat ring and the set ring as sealing means. The elastomeric ring sheets can minimize an apparent elastic coefficient of the metal seat ring, so that sealing properties equal to or exceed a seal structure wherein a metal seat ring is provided integrally with the main body.

A metal seat ring is of large elastic coefficient compared with other materials and cannot vary its shape when contacting with other members. It is therefore difficult for a metal seat ring to obtain preferable sealing properties at the interfacial boundary between the seat ring and the main body and between the seat ring and the set ring. Likewise, sealing properties in relation to the valve plate are inferior. The elastomeric ring sheets, however, provide preferable sealing properties at the interfacial boundaries between them and secure the improved contact with the valve plate by reducing the apparent elastic coefficient of the metal seat ring.

The valve seal structure according to the present invention may be applied to a knife gate valve having a knife-edge portion formed at the lower end of the valve plate. Namely, the present invention also provides a valve seal structure for a knife gate valve having a main body and a valve plate to open and close a flow channel of the main body, wherein a metal seat ring to seal a periphery of the flow channel is prepared separately from the main body and is assembled to the main body at the periphery of the flow channel in a detachable manner by a set ring, and elastomeric ring sheets are provided respectively between the metal seat ring and the main body and between the metal seat ring and the set ring as sealing means.

### BRIEF DESCRIPTION OF THE DRAWINGS

FIG. 1 is a perspective view showing a knife gate valve having a valve seal structure according to the present invention; and,

FIG. 2 is a cross sectional view of the knife gate valve.

### DETAILED DESCRIPTION OF THE PREFERRED EMBODIMENTS

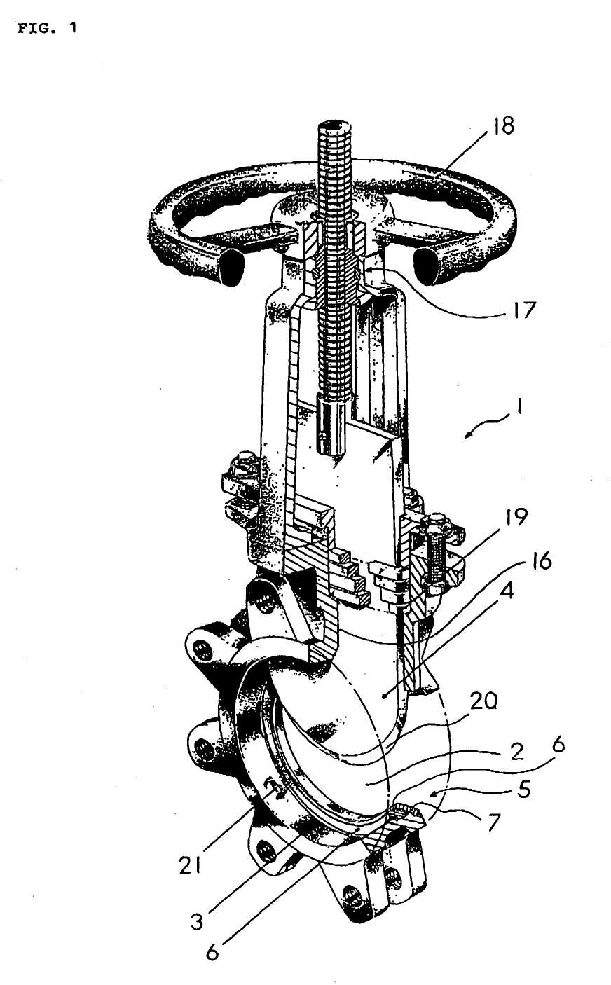

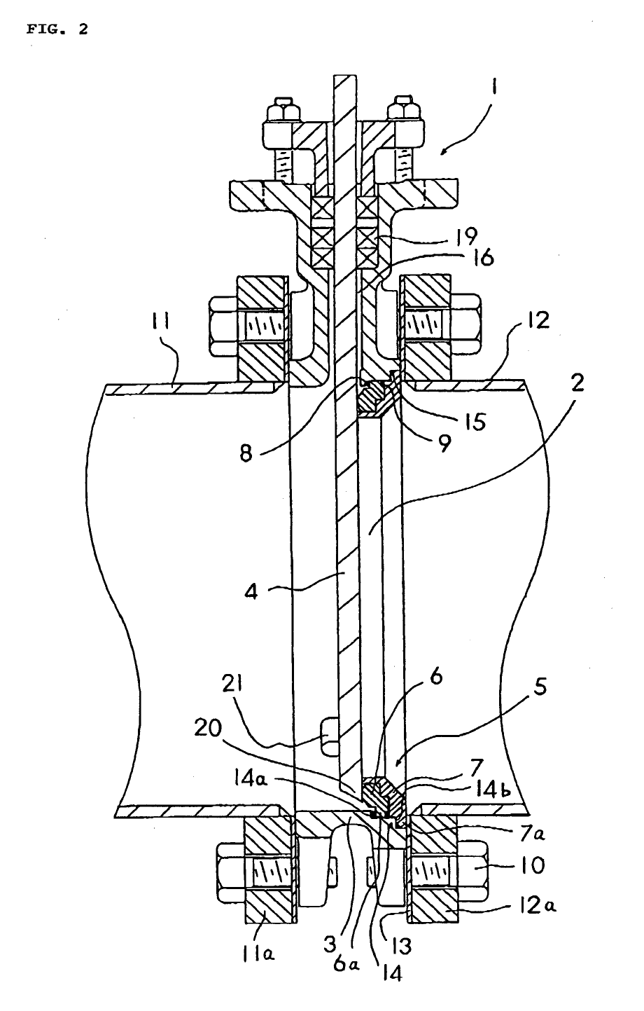

One of the embodiments of the present invention will be described with reference to the accompanying drawings. As shown in FIG. 1 and FIG. 2, the knife gate valve 1 is provided at a connecting portion of a pipeline so as to control fluids flowing inside the pipeline, and the valve 1 is provided with a main body 3 having a flow channel 2 of substantially cylindrical shape through which fluids flow, a valve plate 4 for opening and closing the flow channel 2, and a valve seal structure 5 for sealing the periphery of the flow channel 2.

The valve seal structure 5 is provided with a metal seat ring 6 prepared separately from the main body 3 for sealing the periphery of the flow channel 2, a set ring 7 for assembling the metal seat ring 6 to the main body at the periphery of the flow channel 2 in a detachable manner, a first elastomeric ring sheet 8 for sealing the interfacial boundary between the metal seal ring 6 and the main body 3, and a second elastomeric ring sheet 9 for sealing the interfacial boundary between the metal seat ring 6 and the set ring 7.

The main body 3 is made of, for example, stainless steel which is excellent in durability. To each side of the main body 3, a flange 11a of a primary side pipe 11 and a flange 12a of a secondary side pipe 12 are connected respectively by a bolt 10. Between the main body 3 and the flanges 11a, 12a, gaskets 13 are interposed for sealing the boundaries between the main body 3 and the flanges 11a, 12a. The gaskets 13 also seal the boundary between the main body 3 and the set ring 7.

In the vicinity of a secondary side of the inner periphery of the main body 3, a step-like portion 14 is formed continuously in the circumferential direction of the main body 3 so as to enlarge the inner diameter of the secondary side edge portion. The step-like portion 14 is formed to have two steps in a staircase pattern, which has a first vertical wall 14a near a primary side of the flow channel and a second vertical wall 14b at the secondary side. The first vertical wall 14a determines the position of the metal seat ring 6 and the second vertical wall 14b determines the position of the set ring 7.

The metal seat ring 6 is of a ring-like shape made of, for example, stainless steel, and a radially outwardly projecting flange portion 6a is formed continuously in the circumferential direction. The flange portion 6a is sandwiched between the first vertical wall 14a and the set ring 7a with an intermediate of the first elastomeric ring sheet 8 and the second elastomeric ring sheet 9. The primary side face of the metal seat ring 6 is nearer to the primary side of the flow channel than the first vertical wall 14a and contacts with the valve plate 4 closing the flow channel 2 so as to seal the periphery of the flow channel.

The set ring 7 is of a ring-like shape made of, for example, stainless steel, and a radially outwardly projecting flange portion 7a is formed continuously in the circumferential direction. When the primary side face of the flange portion 7a contacts with the second vertical wall 14b, the flange portion 6a of the metal seat ring 6 is sandwiched between the set ring 7 and the first vertical wall 14a accompanying the compression of the first elastomeric ring sheet 8 and the second elastomeric ring sheet 9.

The set ring 7 has a cross-sectional shape so as to cover the inner periphery and the secondary side face of the metal seat ring 6. The flow channel 2 is surrounded by the inner periphery of the set ring 7A. Accordingly, instead of a metal seat ring, a seat ring made of softer material such as rubber sheet or resin sheet can be also employed.

When the primary side face of the flange portion 7a of the set ring 7 contacts with the second vertical wall 14b, the secondary side face of the set ring 7 is in alignment with the secondary side face of the main body 3. Accordingly, when the flange 12a is secured to the secondary side face of the main body 3, the set ring 7 is sandwiched between the second vertical wall 14b and the flange 12a with an intermediate of the gasket 13.

The flange portion 7a of the set ring 7 has a cutaway corner at the outer periphery, and a seal packing 15 is set at a space formed between the cutaway corner and the main body 3 to seal the boundary between the main body 3 and the set ring 7.

A slit 16 for sliding the valve plate 4 is formed at an upper portion of the main body 3. The upper end of the valve plate 4 is connected to a handle 18 via a screw mechanism, so that the flow gate 2 is opened and closed when the handle 18 is rotated to slide the valve plate 4 along the primary side face of the metal seat ring 6. A gland packing 19 is disposed in the valve yoke of the main body 3 to prevent fluid leakage from the main body 3. The gland packing 19 may be formed in a multi-layer structure by way of combining resin-impregnated knitted packing and molded rubber.

The valve plate 4 is, for example, made of stainless steel, and a knife-edge portion 20 is formed at the lower end to cut foreign substances contained in the fluid to be controlled. Stopper members 21 are formed so as to protrude from the inner circumferential surface of the main body 3 at a plurality of portions of the primary side. These stopper members 21 serves to prevent the knife-edge portion 20 from contacting the inner peripheral surface of the main body 3, and serves to prevent the valve plate 4 from shaking and also serves to enhance the sealing characteristics by pressing the valve plate 4 against the metal seat ring 6 when the knife-edge portion 20 contacts the stopper members 21.

According to the above-mentioned structure, as the metal seat ring is assembled in a detachable manner, a worn out metal seat ring 6 can be replaced with a new seat ring. Furthermore, according to the type of fluid to be handled, the material of the seat ring can be selected from rubber sheets, resin sheets, ceramic sheets etc., depending on the requirements for watertight sealing properties, heat resistance, wear resistance, etc.

The set ring 7 can hold seat rings made of various kinds of materials, so that the metal seat ring is replaced with a seat ring of any other material by removing the metal seat ring 6 and the set ring 7 and then replacing the metal seat ring 6 with a new seat ring.

As the interfacial boundary between the metal seat ring 6 and the main body 3 is sealed by the first elastomeric ring sheet 8 and the interfacial boundary between the metal seat ring 6 and the set ring 7 is sealed by the second elastomeric ring sheet 9, the sealing properties are not adversely affected by preparing the metal seat ring separately from the main body. Furthermore, as both the first elastomeric ring sheet 8 and the second elastomeric ring sheet 9 minimize an apparent elastic coefficient of the metal seat ring 6, the metal seat ring 6 can be contacted more tightly with the valve plate 4, thereby enhancing the sealing properties.

As apparent from the description heretofore, according to the present invention, as a metal seat ring is prepared separately and assembled to a main body in a detachable manner, the metal seat ring can be removed and replaced with a new seat ring when the type of fluid to be controlled changes or when the metal seat ring becomes worn out due to abrasive fluids. Consequently, a single main body can be commonly used to different kinds of fluids and a non-damaged main body need not be replaced. Accordingly, the production cost can be decreased and the maintenance becomes easier.

What is claimed is:

1. A valve seal structure for a valve mechanism having a main body and a valve plate to open and close a flow channel of said main body, wherein a metal seat ring to seal a periphery of said flow channel is prepared separately from said main body and is assembled to said main body at the periphery of said flow channel in a detachable manner.

2. A valve seal structure claimed in claim 1, wherein said metal seat ring is assembled at the periphery of said flow channel by a set ring and elastomeric ring sheets are provided respectively between said metal seat ring and said main body and between said metal seat ring and said set ring as sealing means.

3. A valve seal structure for a knife gate valve having a main body and a valve plate to open and close a flow channel of said main body, wherein a metal seat ring to seal a periphery of said flow channel is prepared separately from said main body and is assembled to said main body at the periphery of said flow channel in a detachable manner by a set ring, and elastomeric ring sheets are provided respectively between said metal seat ring and said main body and between said metal seat ring and said set ring as sealing means.

4. A valve seal structure for a valve mechanism comprising a main body, a valve plate to open and close a flow channel of said main body, a metal seat ring prepared separately from said main body and for sealing a periphery of said flow channel, and a set ring to assemble said metal seat ring to said main body at the periphery of said flow channel in a detachable manner, said main body being provided with a step-like portion having an enlarged inner diameter at the inner peripheral surface in the vicinity of a secondary side of the flow channel, said step-like portion having a first vertical wall near a primary side of the flow channel and a second vertical wall at the secondary side, said metal seat ring and said set ring having a radially outwardly projecting flange portion respectively, a first elastomeric ring sheet being interposed between said flange portion of the metal seat ring as a sealing means and said first vertical wall and a second elastomeric ring sheet being interposed between said flange portion of the metal seat ring and said set ring as a sealing means, and said flange portion of said set ring being assembled so as to contact with said second vertical wall.

5. A valve seal structure for a valve mechanism claimed in claim 4, wherein a seal packing is provided at a space formed between a cutaway corner of the flange portion of the set ring and the main body to seal the boundary between the main body and the set ring.
